(19) United States
(12) Patent Application Publication
(10) Pub. No.: US 2022/0258723 A1
(43) Pub. Date: Aug. 18, 2022

(54) MOTION AND TORQUE CONTROL ARCHITECTURE FOR MOBILE PLATFORM HAVING DISTRIBUTED TORQUE ACTUATORS

(71) Applicant: GM GLOBAL TECHNOLOGY OPERATIONS LLC, Detroit, MI (US)

(72) Inventors: Yiran Hu, Shelby Township, MI (US); Ruixing Long, Windsor (CA); Kevin J. Storch, Brighton, MI (US); Robert C. Gibson, Plymouth, MI (US); Bharath Pattipati, South Lyon, MI (US); Paul G. Otanez, Franklin, MI (US)

(73) Assignee: GM GLOBAL TECHNOLOGY OPERATIONS LLC, Detroit, MI (US)

(21) Appl. No.: 17/175,903

(22) Filed: Feb. 15, 2021

(51) Int. Cl. B60W 20/20; B60W 20/30; B60W 30/18; B60W 30/19

(52) U.S. Cl. CPC B60W 20/20; B60W 20/30; B60W 2510/08; B60W 30/19; B60W 30/18009

(57) ABSTRACT

A motor vehicle includes first and second drive axles coupled to respective sets of road wheels, torque actuators inclusive of rotary electric machines configured to transmit respective output torques to the drive axles, and a main controller in communication with the torque actuators. The controller receives vehicle inputs indicative of a total longitudinal and lateral motion request. In response, the controller calculates a total longitudinal torque request and/or a total longitudinal speed request, a yaw rate request, and a lateral velocity request, then determines, using a cost optimization function, a torque vector for allocating the total longitudinal torque request and/or speed request, the yaw rate request, and the lateral velocity request to the drive axles within predetermined constraints. The controller also transmits a closed-loop control signal to each torque actuator or local controllers thereof to apply the torque vector via the drive axles.

### INTRODUCTION

Rotary electric machines are used as torque actuators in a wide range of electrified powertrains to generate and receive torque during respective discharging and charging operating modes. Battery electric vehicles and hybrid electric vehicles in particular typically include an electric propulsion motor, an output shaft of which is coupled to a drive axle. Multiple electric propulsion motors could be used in some electrified powertrain configurations, either alone or in conjunction with an internal combustion engine. When the various electric propulsion motors are coupled to respective drive axles and/or road wheels, the resulting configuration is referred to in the art as an electric all-wheel drive (eAWD) propulsion system.

### SUMMARY

Disclosed herein are systems, associated control logic, and methods for controlling the real-time operation of a motor vehicle or other mobile platform having distributed/axle-specific torque actuators, including rotary electric machines in an exemplary electric all-wheel drive (eAWD) propulsion system. Unlike powertrain systems in which longitudinal vehicle torque actuation requirements are analyzed and implemented by a centralized propulsion system controller for single-axle propulsion, e.g., via a single electric propulsion motor coupled to a rear or front drive axle, an eAWD propulsion system has multiple independently-actuated drive axles, some of which may include separately-actuated half-axles to provide independent four-corner control in a typical vehicular configuration.

As a result of the evolution of eAWD propulsion systems and enabling fast-actuator technologies, a new torque allocation strategy and control architecture is required for coordinating actuation activity of the various electric propulsion motors arranged on different drive axles, particularly in a manner that considers both longitudinal and lateral vehicle control objectives. Capabilities of additional actuators may be controlled within the scope of the present disclosure, including but not necessarily limited to axle-specific or wheel-specific brake actuators, steering actuators, active aerodynamic and/or roll control actuators, and the like. Collectively, such actuators are controlled in accordance with a model-generated torque vector to affect vehicle/platform dynamics in an optimum manner as set forth herein.

The eAWD propulsion system described herein includes multiple drive axles, with each drive axle being independently coupled to and actuated by a corresponding torque actuator in the form of, at least, a rotary electric machine. Other representative embodiments also include brake actuators and steering actuators as part of the collective group of torque actuators contemplated herein. Within such a propulsion system, the electric machines are configured to function as electric propulsion/traction motors in a discharging/propulsion mode, i.e., when an onboard high-voltage battery pack, fuel cell, or other power supply is discharged at a controlled rate to power the electric machines. Such electric machines may also operate as needed in their capacities as electric generators, i.e., during power generating modes of operation, as appreciated in the art.

In particular, the present teachings relate to a controller-implemented architecture that incorporates longitudinal torque and lateral motion control objectives into a single, multi-axle torque distribution optimization strategy. The disclosed strategy, much of which is executed by a main controller in communication with distributed local/actuator-level control units, e.g., motor control processors (MCPs) of the above-noted electric machines, simultaneously optimizes drive performance for longitudinal and lateral vehicle dynamics. Torque allocation is subject to calibrated performance limits, including hardware limits, axle interventions, dynamic, thermal, and/or electrical limits, and/or external requestor limits as set forth herein.

In a representative embodiment, a motor vehicle includes first and second drive axles respectively coupled to first and second sets of road wheels, and a plurality of torque actuators inclusive of rotary electric machines, each configured to transmit respective output torques to the first and/or second drive axles. The torque actuators contemplated herein may also include, by way of example, steering actuators, brake actuators, and/or other application-suitable torque actuators acting on the separate drive axle(s) and/or the road wheels connected thereto.

A main controller is in communication with the torque actuators, and is programmed with calibrated constraints. The main controller is configured to receive a set of vehicle inputs indicative of a total longitudinal motion request and a total lateral motion request of the motor vehicle, and to calculate, using the vehicle inputs, a total longitudinal torque request and/or a total longitudinal speed request, a yaw rate request, and a lateral velocity request of the motor vehicle.

The main controller also determines an optimal torque vector, as well as optimal setpoints for other considered actuators, by using a cost optimization function. The torque vector allocates the total longitudinal torque request and/or the total longitudinal speed request, the yaw rate request, and the lateral velocity request to the first drive axle and/or the second drive axle, within/bounded by the calibrated set of constraints. A closed-loop control signal is then transmitted by the main controller to each of the torque actuators, or associated local control processors thereof, to thereby apply the torque vector via the first drive axle and/or the second drive axle.

The torque actuators may include a first electric machine coupled to the first drive axle and a second electric machine coupled to the second drive axle. In such an embodiment, the first drive axle and/or the second drive axle may include a respective pair of half-axles. The first electric machine and/or the second electric machine may include a respective pair of electric machine each coupled to a respective one of the half-axles.

The torque actuators may optionally include one or more brake actuators connected to a respective one of the first drive axle and the second drive axle.

The above-noted constraints may include, in an exemplary configuration, separate hardware constraints, operating constraints, and/or external function constraints.

In some implementations, the torque vector is configured to optimize wheel slip of the first and/or the second sets of road wheels.

The cost optimization function executed by the main controller may be configured to optimize the torque vector for present tire capacity of the first and/or second sets of road wheels. The cost optimization function could also be configured to optimize the torque vector for propulsion efficiency of the motor vehicle, or for other outcomes in different embodiments.

In a possible configuration, the first and second sets of road wheels are respective front and rear road wheels, either or both of which are independently steerable via respective steering actuators. In such a configuration, the torque actuators could include the respective steering actuators.

An optional mode selection device may be configured to receive an operator-requested or autonomously-requested mode selection signal, with the main controller configured to modify weights within the cost optimization function in response to the mode selection signal.

In a possible variation, the torque actuators may include an internal combustion engine configured to generate an engine output torque, and at least one electronically-controlled differential coupled to the internal combustion engine. The electronically-controlled differential(s) in such an embodiment may be configured to receive the engine output torque therefrom.

A method is also disclosed herein for controlling motion and torque in a motor vehicle having an eAWD propulsion system as detailed above. The method includes receiving the set of vehicle inputs via the main controller, with the vehicle inputs indicative of a total longitudinal motion request and a total lateral motion request of the motor vehicle. The constraints in this representative embodiment include hardware constraints, operating constraints, and/or external function constraints.

The method includes calculating, using the set of vehicle inputs, a total longitudinal torque request and/or a total longitudinal speed request, a yaw rate request, and a lateral velocity request of the motor vehicle. The method also includes determining, using a cost optimization function, a torque vector for allocating the total longitudinal torque request and/or the total longitudinal speed request, the yaw rate request, and the lateral velocity request to the first drive axle and the second drive axle within the calibrated set of constraints. Additionally, the method includes transmitting a closed-loop control signal to each of the torque actuators to thereby apply the torque vector via the first drive axle and the second drive axle, respectively.

The above-noted and other features and advantages of the present disclosure will be readily apparent from the following detailed description of the embodiments and best modes for carrying out the disclosure when taken in connection with the accompanying drawings and appended claims.

### BRIEF DESCRIPTION OF THE DRAWINGS

FIG. 1 is a schematic illustration of an exemplary motor vehicle having an electric all-wheel drive (eAWD) propulsion system and a main controller configured to execute the present method.

FIG. 2 is a flow chart describing an exemplary method for allocating torque in the eAWD propulsion system of FIG. 1.

FIG. 3 is a schematic logic flow diagram depicting exemplary control logic for use with the motor vehicle of FIG. 1 when implementing the present method.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

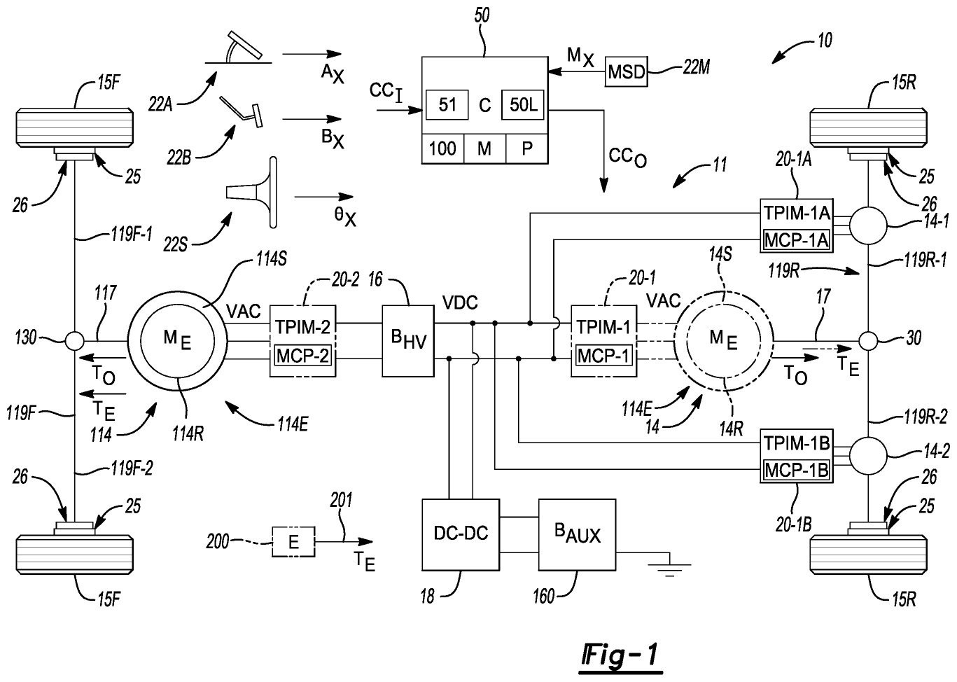

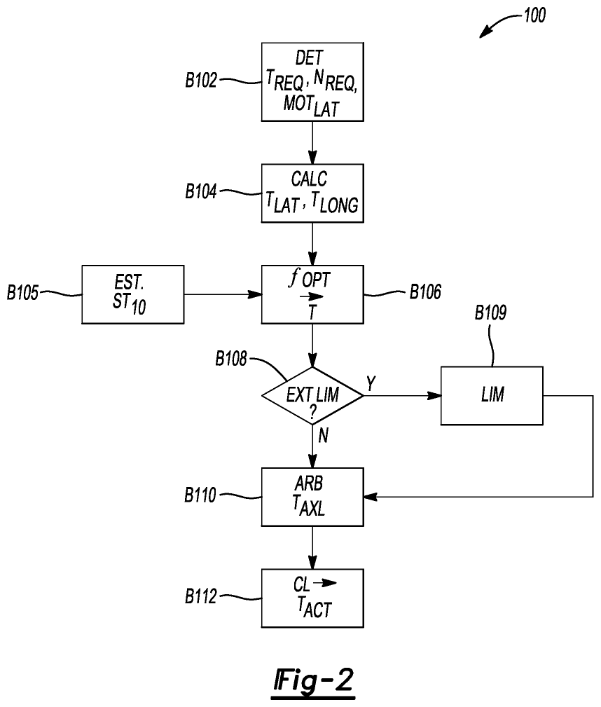

Referring to the drawings, wherein like reference numbers refer to like components, FIG. 1 schematically depicts a representative motor vehicle 10 or another mobile platform having an electric all-wheel drive (eAWD) propulsion system 11 configured as set forth herein. The eAWD propulsion system 11 includes multiple rotary electric machines (M_{E}) 114E, including a rear propulsion motor 14 and a front propulsion motor 114 in a simplified embodiment. Primary torque functions of the electric machines 114E are regulated in real time via control signals (arrow CC_{O}) from a main controller (C) 50, i.e., a centralized/supervisory control system as set forth below. Instructions for implementing a torque distribution control strategy in accordance with the present disclosure are embodied as a method 100, an example of which is depicted in FIG. 2. Such instructions may be recorded in memory (M) of the controller 50 and executed by one or more processors (P) using associated control logic 50L to provide the benefits described herein, with memory (M) programmed with a cost optimization function 51 as set forth in detail below.

Other powertrain components may be included within the eAWD propulsion system 11, such as but not limited to an optional internal combustion engine (E) 200 with an output shaft 201 providing an engine torque (arrow T_{E}) in a possible hybrid electric configuration, as well as a DC-DC converter (DC-DC) 18 and an auxiliary battery (B_{AUX}) 160. As appreciated in the art, high-voltage propulsion operations may entail voltage levels of 300V or more, while onboard low-voltage/auxiliary functions are typically powered by 12-15V power. Thus, “low-voltage” and “auxiliary voltage” as used herein refer to nominal 12V power levels, with “high-voltage” referring to voltage levels well in excess of auxiliary voltage levels. The DC-DC converter 18 is therefore operable through internal switching operations and signal filtering, as understood in the art, to receive a relatively high DC voltage from a DC voltage bus (VDC) and output the auxiliary voltage to the auxiliary battery 160.

The representative motor vehicle 10 of FIG. 1 includes front road wheels 15F arranged on a front drive axle 119F, and rear road wheels 15R arranged on a rear drive axle 119R. Depending on the configuration, electronically-controllable differentials 30 and/or 130 may be used to distribute the optional engine torque (arrow T_{E}) and/or output torque (arrows T_{O}) from the electric machines 114E to the front and/or rear road wheels 15F and/or 15R of the motor vehicle 10 in different drive modes.

The front and rear drive axles 119F and 119R in some embodiments may implement the front drive axle 119F as half-axles 119F-1 and 119F-2, with the rear drive axle 119R likewise implementable as half-axles 119R-1 and 119R-2. In such an embodiment, half-axles 119F-1 and 119F-2 may be connected to the electronically-controllable differential 130. The half-axles 119R-1 and 119R-2 could be connected to the electronically-controllable differential 30, with this configuration enabling independent torque distribution to the front road wheels 15F and/or the rear road wheels 15R as part of the method 100. The present strategy in different embodiments may be extended to configurations: (1) one using a single propulsion source, e.g., the electric machine 114E, which is attached to an electronically-limited slip differential (eLSD), which would allow torque variation between left and right sides of a given drive axle, and (2) separate electric machines 114E each connected to one of the road wheels 15R or 15F directly, i.e., with no mechanical connection between the left and right sides. Thus, option (2) foregoes use of the above-noted differentials 30 and 130.

Shown schematically for illustrative clarity and simplicity, in some embodiments the front road wheels 15F and the rear road wheels 15R may be independently-steerable via a corresponding steering actuator 26. Likewise, the front road wheels 15F and the rear road wheels 15R may be independently slowed via a corresponding brake actuator 26. Such brake actuators 26 could be independently controlled and connected to a given road wheel 15F or 15R or half-axle 119F-1, 119F-2, 119R-1, 119R-2, or a single brake actuator 26 could arrest rotation of the road wheels 15F or 15R coupled to a given drive axle 119F or 119R, e.g., as an electronic brake actuator. Thus, for applications in which torque from propulsion actuators such as the electric machines 114E are not available on individual axles, some level of torque control is still possible via the brake actuators 26.

The steering actuators 25 and the brake actuators 26 are respectively responsive to pressure or travel of an accelerator pedal 22A and brake pedal 22B, which generates a corresponding accelerator request signal (arrow A_{X}) and braking request signal (arrow B_{X}). An operator of the motor vehicle 10 may, using a steering wheel 22S, impact a steering angle (arrow θ_{X}), which is read by the main controller 50 as part of a set of input signals (arrow CC_{I}), along with the accelerator request signal (arrow A_{X}) and braking request signal (arrow B_{X}). The main controller 50 may also receive a mode selection signal (arrow M_{X}) from an optional mode selection device (MSD) 22M as part of the input signals (arrow CC_{I}), with operation of the mode selection device 22M described in more detail below.

Still referring to FIG. 1, the eAWD propulsion system 11 is shown in an embodiment in which the front propulsion motor 114 is connected to the front drive axle 119F via an output member 117, e.g., a rotary shaft and possible gearset. The front propulsion motor 114 may be embodied as an alternating current (AC) device in which a wound stator 114S draws a single phase or polyphase electrical current from an onboard direct current (DC) power supply, shown in FIG. 1 as a representative high-voltage battery pack (B_{HV}) 16, e.g., a multi-cell lithium-ion battery. In such an embodiment, the battery pack 16 is connected to the wound stator 114S via a traction power inverter module (TPIM-2) 20-2, with a corresponding motor control processor (MCP-2) locally controlling output torque and speed of the front propulsion motor 114 in response to the output signals (arrow CC_{O}). The wound stator 114S, once energized, generates a rotating electromagnetic field that interacts with a field of a magnetic rotor 114R, which may be circumscribed by the wound stator 114S in a typical rotary flux configuration.

The eAWD propulsion system 11 may employ a similar setup for powering the rear road wheels 15R. For example, the rear propulsion motor 14 may include a rotor 14R circumscribed by a wound stator 14S, with the rear propulsion motor 14 energized via a corresponding TPIM-1 20-1 having a resident/local motor control processor, i.e., MCP-1. Rear propulsion motor 14 could be coupled to the differential 30 via an output member 17 as shown, with the output member 17 transmitting its own output torque (arrow T_{O}) to the rear road wheels 15R.

In a possible alternative configuration, independent torque control may be provided over the individual rear road wheels 15R by arranging separate rear propulsion motors 14-1 and 14-2 on the respective half-axles 119R-1 and 119R-2. The rear propulsion motors 14-1 and 14-2 in such an embodiment may be individually connected to a corresponding TPIM 20-1A and 20-1B (TPIM-1A and TPIM 1-B, respectively), in lieu of using the single TPIM 20-1 for a single rear propulsion motor 14. Although omitted for illustrative clarity, one skilled in the art will appreciate that the single front propulsion motor 114 may be similarly replaced by separate electric propulsion motors coupled to each of the half-axles 119F-1 and 119F-2, to independently power the front road wheels 15F on opposing sides of the motor vehicle 10.

The term “controller” as used herein for descriptive simplicity may include one or more electronic control modules, units, processors, and associated hardware components thereof, e.g., Application Specific Integrated Circuits (ASICs), systems-on-a-chip (SoCs), electronic circuits, and other hardware as needed to provide the programmed functionality. For a representative three-motor configuration, such as is shown in an embodiment in FIG. 1, the main controller 50 could be a motor controller for a drive axle having a single drive unit, e.g., the front drive axle 119F in an embodiment in which the electric propulsion motor 114 of FIG. 1 is used. Such an arrangement may help ensure balanced controller area network (CAN) communication delay between the main controller 50 and the various secondary controllers in communication therewith, e.g., MCP-1, MCP-1A, MCP-1B, and MCP-2, as well as local controllers for the brake actuators 26 and steering actuators 25. Axle-based control functions could then be allocated to such local controllers to enable faster local feedback-based control over the individual drive axles 119F, 119R, 119F-1, 119-F2, 119R-1, and/or 119R-2, such that wheel slip and other fast dynamics can be managed in real-time or preemptively.

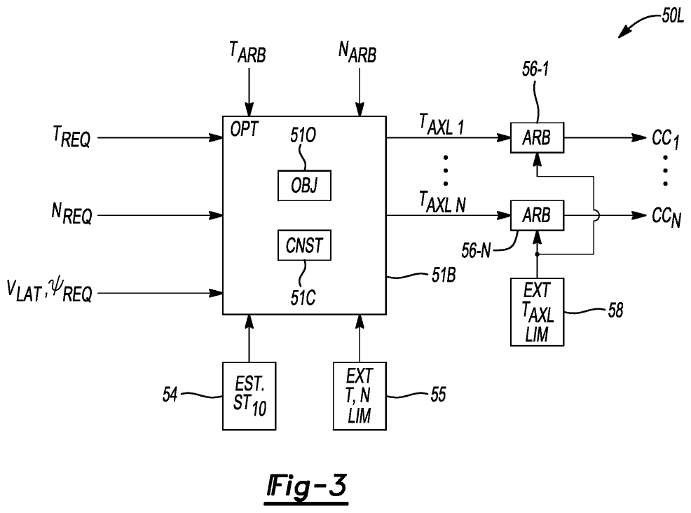

The main controller 50 of FIG. 1, representative control logic 50L for which is depicted in FIG. 3, may be embodied as one or more electronic control units or computational nodes responsive to the input signals (arrow CC_{I}). The controller 50 includes application-specific amounts of the memory (M) and one or more of the processor(s) (P), e.g., microprocessors or central processing units, as well as other associated hardware and software, for instance a digital clock or timer, input/output circuitry, buffer circuitry, etc. The memory (M) may include sufficient amounts of read only memory, for instance magnetic or optical memory.

FIGS. 2 and 3 respectively depict the method 100 according to an exemplary embodiment, and a corresponding set of control logic 50L for implementing the method 100 aboard the motor vehicle 10. The method 100 of FIG. 2 is intended to incorporate lateral vehicle dynamics objectives into a torque control architecture, executed proactively by the main controller 50. As part of the present strategy, lateral motion objectives such as desired yaw rate and lateral velocity are used as optimization objectives. This occurs in addition to the traditional longitudinal objectives typically determined using a driver's total torque and speed requests.

In particular, execution of the method 100 involves multi-objective optimization/arbitration to determine an optimum torque distribution over multiple axles, such as the representative drive axles 119F and 119R of FIG. 1 or their half-axle variants. Axle-based arbitration is then used after optimization to provide additional flexibility to enforce external axle-based interventions or other performance limits as needed to protect underlying hardware, operating limits, stability or other dynamic limits, etc.

Referring to FIG. 2, the main controller 50 is in communication with local controllers of a plurality of torque actuators, including the above-described electric machines 114E, and possibly including the brake actuators 26 and/or the steering actuators 25, the electronically-controllable differentials 30 and 130, etc. The main controller 50 at block B102 of FIG. 2, previously programmed with a calibrated set of constraints, is configured to receive the set of vehicle inputs (arrow CC_{I} of FIG. 1) indicative of a total longitudinal motion request of the motor vehicle 10, exemplified as a total requested torque (T_{REQ}) and/or a total speed request (N_{REQ}) of the motor vehicle 10, along with a lateral motion request (MOT_{LAT}) of the motor vehicle 10.

In a typical use scenario, for example, a driver of the motor vehicle 10 in FIG. 1 may generate the total torque request (T_{REQ}) and total speed request (N_{REQ}) using acceleration and braking requests, e.g., by depressing the accelerator pedal 22A and brake pedal 22B. The lateral motion request (MOT_{LAT}) may be determined in part using steering angle (arrow θ_{X}) of FIG. 1. In autonomous embodiments, such vehicle inputs (arrow CC_{I} of FIG. 1) may be automatically generated by the main controller 50 and/or another dedicated control unit. The method 100 then proceeds to block B104.

At block B104, the main controller 50 calculates, using the set of vehicle inputs from block B102, separate total lateral and longitudinal torque or motion requests (T_{LAT} and T_{LONG}, respectively). As part of block B104, the main controller 50 may calculate a yaw rate request and a lateral velocity request of the motor vehicle 10, again using the steering angle (arrow θ_{X}) as a relevant input. The method 100 then proceeds to block B106.

Block B105 of FIG. 2 in this embodiment includes estimating the present state of the motor vehicle 10 (EST ST₁₀). As appreciated in the art, state estimation is typically used in vehicular applications to monitor, e.g., present velocity, attitude (pitch, yaw, and roll), the present states of various propulsors (e.g., the electric machines 114E, the engine 200, etc.), a state of charge, temperature, voltage, current, and/or other relevant electrical parameters, in this case of the battery pack 16 of FIG. 1. State estimation may also consider tire pressure and capacity, current or impending wheel slip of one or more of the road wheels 15R an 15F, etc. Using trajectories of such values, the main controller 50 is able to predict the state of the motor vehicle 10 at a future instant in time. The present state of the motor vehicle 10 is therefore fed into the cost optimization function 51 of FIG. 1, such that the main controller 50 is aware of the present state before commencing optimization calculations specific to the method 100.

Block B106 of the method 100 includes determining, via the main controller 50 using the cost optimization function (f_{OPT}) 51 of FIG. 1, a torque vector \vec{T} for allocating the total longitudinal torque request and/or the total longitudinal speed request, the yaw rate request, and the lateral velocity request to the front drive axle 119F and/or the rear drive axle 119R within the calibrated set of constraints noted above. As used herein and in the art, for instance, a torque vector for a simplified three-motor/dual-axle may be in the form \vec{T}=[A, B, C], where A, B, and C are the torque allocated to different drive axles A, B, and C.

As will also be appreciated in the art, cost function-based optimization strategies abound in which dynamic models in the form of mathematical equations are used to optimize a given outcome in the presence of competing values and constraints. As an example, the dynamic model used for optimization provides the dynamic relationship between the manipulated actuators, e.g., torque distribution, friction brake torques, rear steering, etc., and vehicle dynamic states such as longitudinal velocity/acceleration, lateral velocity/acceleration, yaw rate, wheels speeds, etc. Optimization as performed herein may use such a dynamic model to predict an expected vehicle response from actuator setpoints, and then select appropriate actuator setpoints that collectively optimize the cost function 51 for the predicted trajectories. To implement the cost optimization function 51 used herein, for instance, the main controller 50 may be programmed with relevant tracking functions, e.g., for desired longitudinal velocity, longitudinal torque request, desired yaw rate, etc., while constraining for the above-noted set of constraints.

Constraints can be both soft and hard depending on whether or not the constraint can be occasionally violated (soft) or not (hard). Optimization simultaneously considers all of the costs within the cost function 51, and finds optimal actuator setpoints, e.g., a corresponding torque vector, that minimizes the cost and provides an optimal tradeoff between objectives. Penalties could be applied in real-time by overweighting certain factors, such as energy consumption or stability, e.g., by adjusting numeric weights in the mathematical equations.

Exemplary constraints that could be taken into consideration by the main controller 50 may include, but are not limited to, the tracking of a most efficient torque split between the drive axles 119F and 119R and/or the various road wheels 15F and 15R, constraining wheel slip to a given slip ratio, constraining each assigned axle torque to a corresponding estimated tire capacity, constraining longitudinal velocity for overspeed control, or constraining the total torque to enforce external total torque constraints. As such considerations can be mathematically modeled in various forms, optimization in the scope of the disclosure, and thus the optimum solution to a given set of dynamic modeling equations, could, in a non-limiting embodiment, entail finding the least-cost solution.

As part of block B106, the main controller 50 could receive the mode selection signal (arrow M_{X} of FIG. 1) from the mode selection device 22M, whether operator-requested or autonomously-requested. The main controller 50 could then modify weighting within the above-noted cost optimization functions in response to the mode selection signal. For instance, if a driver selects “sport mode”, lateral performance objectives, such as meeting a driver-desired yaw rate, may be prioritized over factors such as powertrain efficiency, with unitless weights respectively penalizing or preferring certain combinations of torque actuation to achieve the performance expected by the indicated mode.

The torque vector could likewise be optimized at block B106 for wheel slip of the front and/or rear road wheels 15F and/or 15R in a similar manner, such as by penalizing distributions that would result in wheel slip, or that would exacerbate existing wheel slip conditions at one or more of the road wheels 15F and/or 15R. For example, in order to simultaneously avoid exceeding a slip ratio threshold on one road wheel 15F or 15R, while also still meeting the driver's total torque request, the optimization function 51 automatically shifts torque distribution to place more torque on the road wheels 15F or 15R having less slip, and less torque on the road wheels 15F or 15R that are exceeding he slip ratio.

Likewise, block B106 could entail optimizing the torque vector for the present tire capacity of the front and/or rear road wheels 15F and/or 15R, which could preempt slip conditions. In this case, the optimization function 51 would predict, based on the present tire capacity and vehicle dynamics model used by the optimization function 51, that some potential torque distributions would result in unacceptable wheel slip at some of the road wheels 15F or 15R, thus negatively affecting the ability of the motor vehicle 10 to meet the driver's longitudinal torque or speed request. As a result, optimization would automatically avoid such potential distributions as minimizing the cost function, and would instead find other distributions that better meet the driver's longitudinal torque or speed requests. That is, torque distribution to different axles could be optimized for wheel slip, with possible control actions including preemptive distribution of the torque based on knowledge of tire capacity at each road wheel, as well as reactive distribution when excessive slip is actually observed on any of the road wheels.

The main controller 50 could also optimize the torque vector \vec{T} for propulsion efficiency of the motor vehicle 10, i.e., by returning solutions that favor energy efficiency over other factors such as speed or cornering performance. The latter optimization could penalize torque allocation that would reduce electrical efficiency of the battery pack 16 of FIG. 1, for instance, or that would increase electrical energy or fuel consumption in embodiments in which the eAWD propulsion system 11 includes the engine 200.

Illustrative examples may be contemplated that tie efficiency considerations together with one or more other objectives, with compromises or tradeoffs made along the way as set forth above. For instance, one might consider a scenario in which the motor vehicle 10 of FIG. 1 is driving straight down a road. In this case, the motor vehicle 10 would follow the most efficient torque distribution, as such a distribution is also optimal for the longitudinal and lateral responses desired by the driver. Alternatively, the same driver might attempt an aggressive cornering maneuver. In such a case, the most efficient torque distribution might not meet the driver's desired longitudinal and lateral responses. As a result, the optimization function 51 and attendant control strategy would make a tradeoff between efficiency and lateral request based on how heavily each is weighted.

After performing such optimization at block B106 of FIG. 2, the method 100 proceeds to block B108, with the main controller 50 determining external limits or axle interventions. Such limits could be communicated to the main controller 50 from a different control unit, e.g., an electronic stability control or traction control module, or such limits could originate from different functions residing aboard the main controller 50. Limits could include calibrated hardware limits intended to protect the structural integrity of the various components of the eAWD propulsion system 11, such as associated thermal, torque, acceleration, or other suitable thresholds, as well as dynamic limits accounting for stability, traction, or other performance restrictions.

Collectively, the limits considered in block B108 are then applied at block B109 (LIM) to adjust the torque vector output of block B108 as needed to account for the limits. The method 100 then proceeds to block B110.

Block B110 includes performing axle based arbitration (ARB T_{AXL}) via the main controller 50. As a possible implementation of block B110, such arbitration could include determining, via the main controller 50, whether to follow an optimal torque request generated at block B106, or the request from the external function and limits applied in blocks B108 and B109. Weighting of an external requester function ensures that the main controller 50 selects the request from the external function under appropriate conditions, e.g., during a high-slip traction control event.

The torque vector \vec{T} created by optimization at block B106 is thus not sent to the various torque actuators in such a case, but rather the request from external requester, e.g., an anti-lock braking system (ABS). Under operating conditions in which the external requestor takes low priority, e.g., under normal driving conditions, the opposite arbitration decision is made by block B110, with the optimal torque request generated at block B106 applied via the torque vector. The method 100 then proceeds to block B112.

At block B112 of FIG. 2, the main controller 50 transmits a closed-loop control signal (CL→T_{ACT}) to each of the torque actuators, i.e., the electric machines 114E, the brake actuators 26, the steering actuators 25, the differentials 30 and 130, etc., to thereby apply the torque vector \vec{T} via the front drive axle 119F and/or the second drive axle 119R. The individual torque actuators and associated local controllers thus respond to these instructions with a corresponding output, be it a braking pressure, a steering response, or a motor torque, as appropriate for the actuator typ.

Referring to FIG. 3, representative control logic 50L is shown for implementing the above-described method 100 and alternative embodiments within the scope of the disclosure. For instance, the cost optimization function 51 described above may be implemented as an optimization logic block (OPT) 51B, inclusive of (a) optimization objectives 51O and (b) optimization constraints 51C. Such optimization block 51B is aware of allocations from a prior time step to determine optimal torque distribution at a next time step, i.e., the optimization logic block 51B is iterative.

The optimization objectives 51O correspond to optimization of axle torque requests to meeting defined tracking objective functions, as noted above, with calibratable weighting to balance priorities between such objectives. The optimization constraints 51C likewise limit the optimization outcomes, such as by enforcing calibrated maximum toque to the sum of the individual axle torques, or restricting vehicle speed to a speed constraint, or ensuring axle torque requests satisfy propulsion system constraints such as battery power limits, a wheel slip ratio, etc.

Logic block 51B in communication with the various input devices shown in FIG. 1, i.e., the accelerator pedal 22A, the brake pedal 22B, and the steering wheel 22S. In response to driver actuation of the pedals 22A and/or 22B, or rotation of the steering wheel 22S, the optimization logic block 51B receives the torque request (arrow T_{REQ}), speed request (arrow N_{REQ}), lateral velocity (V_{LAT}), requested yaw rate (ψ_{REQ}), along with arbitrated torque (arrow T_{ARB}) and arbitrated speed (N_{ARB}) from block B110 of FIG. 2. Likewise, logic block 51B receives the estimated state of the motor vehicle 10 from a state estimation block 54, corresponding to block B105 of FIG. 2, and external torque and speed limits from an external limit block 55 corresponding to blocks B108 and B109 of FIG. 2. Thus, external requestors have override priority in determining axle torque requests are arbitrated after optimization of the axle torque requests. A possible implementation in the optimization scheme therefore includes imposing the external requestor with a highest priority or weight as an additional hard constraint on the affected axle(s).

Outputs from Logic block 51B in FIG. 3 include initial axle torque commands (T_{AXL1}, . . . , T_{AXLN}) for N drive axles, with N=2 in a simplified two-axle embodiment, up to N=4 in an embodiment of FIG. 1 in which independent control of the four corners of the motor vehicle 10 is used with four different drive axles. Arbitration blocks 56-1, . . . , 56-N are used to implement block B110 of FIG. 2, and to arbitrate the initial axle torque commands (T_{AXL1}, . . . , T_{AXLN}) in view of external axle torque limits (EXT T_{AXL} LIM) from external requestor block 58. Thereafter, the main controller 50 transmits closed-loop control signals to the individual torque actuators in accordance with block B112 of FIG. 2, with arrows CC₁, . . . , CC_{N} being indicative of such control signals in FIG. 3.

The present strategy could also be employed in cases for which the output of the local controllers, e.g., MCP-1, MCP-2, MCP-1A, or MCP-1B of FIG. 1, is also a command and/or modification to the steering actuators 25. In this case, a given local controller could be programmed with the ability to deliver a yaw rate based on the steering angle command and the torque vectoring occurring via the electric machines 114E and/or brake actuator(s) 26.

As will be appreciated by those skilled in the art in view of the foregoing disclosure, the present strategy enables a sum of individual axle torques to be controlled in a closed-loop to track a total driver torque or speed request in different operating modes. Relative weighting of the associate costs or penalties are used to select a priority between different control objectives, with such costs possibly tuned using calibratable or selectable weights based on driving conditions or operating mode. Within these capabilities, torque allocations remain subject to propulsion system constraints such as axle torque limits, e.g., motor limits and half-shaft limits, battery power limits, and the like. The present teachings thus enable a new architecture for coordinating operation of different torque actuators arranged on different drive axles to achieve both longitudinal and lateral vehicle control objectives. These and other benefits will be readily appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

1. A motor vehicle comprising:
a first drive axle coupled to a first set of road wheels;
a second drive axle coupled to a second set of road wheels;
a plurality of torque actuators each connected to the first drive axle or the second drive axle, and configured to transmit respective output torques to the first drive axle and/or the second drive axle, the plurality of torque actuators including multiple rotary electric machines; and
a main controller in communication with the plurality of torque actuators, wherein the main controller is programmed with a calibrated set of constraints and configured to:
receive a set of vehicle inputs indicative of a total longitudinal motion request and a total lateral motion request of the motor vehicle;
calculate, using the set of vehicle inputs, a total longitudinal torque request and/or a total longitudinal speed request, a yaw rate request, and a lateral velocity request of the motor vehicle;
determine, using a cost optimization function, a torque vector for allocating the total longitudinal torque request and/or the total longitudinal speed request, the yaw rate request, and the lateral velocity request to the first drive axle and the second drive axle within the calibrated set of constraints; and
transmit a closed-loop control signal to each of the torque actuators to thereby apply the torque vector via the first drive axle and the second drive axle, respectively.

2. The motor vehicle of claim 1, wherein the multiple rotary electric machines include a first electric propulsion motor coupled to the first drive axle and a second electric propulsion motor coupled to the second drive axle.

3. The motor vehicle of claim 2, wherein the first drive axle and/or the second drive axle includes a respective pair of half-axles, and wherein the first electric propulsion motor and/or the second electric propulsion motor includes a respective pair of electric propulsion motors each coupled to a respective one of the half-axles.

4. The motor vehicle of claim 1, wherein the plurality of torque actuators includes one or more brake actuators connected to a respective one of the first drive axle and the second drive axle.

5. The motor vehicle of claim 1, wherein the set of constraints includes hardware constraints, operating constraints, and/or external function constraints.

6. The motor vehicle of claim 1, wherein the torque vector is configured to optimize wheel slip of the first set of road wheels and/or the second set of road wheels.

7. The motor vehicle of claim 1, wherein the cost optimization function is configured to optimize the torque vector for present tire capacity of the first set of road wheels and the second set of road wheels.

8. The motor vehicle of claim 1, wherein the cost optimization function is configured to optimize the torque vector for propulsion efficiency of the motor vehicle.

9. The motor vehicle of claim 1, wherein the first set of road wheels and the second set of road wheels are respective front and rear road wheels, the first set of road wheels and/or the second set of road wheels are steerable via respective steering actuators, and the plurality of torque actuators includes the respective steering actuators.

10. The motor vehicle of claim 1, further comprising: a mode selection device configured to receive an operator-requested or autonomously-requested mode selection signal, wherein the controller is configured to modify weighting within the cost optimization function in response to the mode selection signal.

11. The motor vehicle of claim 1, wherein the plurality of torque actuators includes an internal combustion engine configured to generate an engine output torque inclusive of the output torques, and an electronically-controlled differential coupled to the internal combustion engine, the electronically-controlled differential being configured to receive the engine output torque therefrom.

12. A method for controlling motion and torque in a motor vehicle having a first drive axle coupled to a first set of road wheels, a second drive axle coupled to a second set of road wheels, and a plurality of torque actuators each connected to the first drive axle and/or the second drive axle, the plurality of torque actuators including multiple rotary electric machines configured to transmit respective output torques to the first drive axle and/or the second drive axle, the method comprising:
receiving a set of vehicle inputs via a main controller programmed with a calibrated set of constraints, wherein the set of vehicle inputs is indicative of a total longitudinal motion request and a total lateral motion request of the motor vehicle, the set of constraints including hardware constraints, operating constraints, and/or external function constraints;
calculating, using the set of vehicle inputs, a total longitudinal torque request and/or a total longitudinal speed request, a yaw rate request, and a lateral velocity request of the motor vehicle;
determining, using a cost optimization function, a torque vector for allocating the total longitudinal torque request and/or the total longitudinal speed request, the yaw rate request, and the lateral velocity request to the first drive axle and the second drive axle within the calibrated set of constraints; and
transmitting a closed-loop control signal to each of the torque actuators to thereby apply the torque vector via the first drive axle and the second drive axle, respectively.

13. The method of claim 12, wherein the multiple rotary electric machines includes a first electric propulsion motor coupled to the first drive axle and a second electric propulsion motor coupled to the second drive axle, and wherein transmitting the closed-loop control signals to each of the torque actuators includes transmitting the closed-loop control signals to the first electric propulsion motor and the second electric propulsion motor.

14. The method of claim 12, wherein the first drive axle and/or the second drive axle includes a respective pair of half-axles, and the first electric motor and/or the second electric propulsion motor includes a respective pair of electric propulsion motors each coupled to a respective one of the half-axles, and wherein transmitting the closed-loop control signals to each of the torque actuators includes transmitting the closed-loop control signals to the respective pair of electric propulsion motors.

15. The method of claim 12, wherein the plurality of torque actuators includes one or more brake actuators connected to a respective one of the first drive axle and the second drive axle, and wherein transmitting the closed-loop control signals to each of the torque actuators includes transmitting closed-loop braking control signals to the one or more brake actuators.

16. The method of claim 12, wherein determining the torque vector for allocating the total longitudinal torque request and/or the total longitudinal speed request includes optimizing wheel slip of the first set of road wheels and/or the second set of road wheels via the cost optimization function.

17. The method of claim 12, wherein determining the torque vector for allocating the total longitudinal torque request and/or the total longitudinal speed request includes optimizing the torque vector for present tire capacity of the first set of road wheels and the second set of road wheels.

18. The method of claim 12, wherein determining the torque vector for allocating the total longitudinal torque request and/or the total longitudinal speed request includes optimizing propulsion efficiency of the motor vehicle.

19. The motor vehicle of claim 1, wherein the first set of road wheels and the second set of road wheels are respective front and rear road wheels, the first set of road wheels and/or the second set of road wheels are steerable via respective steering actuators, and the plurality of torque actuators includes the respective steering actuators, and wherein transmitting the closed-loop control signal to each of the torque actuators includes transmitting a closed-loop steering control signal to the respective steering actuators.

20. The method of claim 12, wherein the motor vehicle includes a mode selection device configured to receive an operator-requested or autonomously-requested mode selection signal, the method further comprising: automatically adjusting weights within the cost optimization function via the main controller in response to the mode selection signal.
